(19) United States
(12) Patent Application Publication
(10) Pub. No.: US 2010/0079714 A1
(43) Pub. Date: Apr. 1, 2010

(54) LIQUID CRYSTAL DISPLAY DEVICE AND MANUFACTURING METHOD THEREOF

(75) Inventors: Minoru SHIBAZAKI, Hyogo (JP); Masahide INOUE, Hyogo (JP)

Correspondence Address: LOWE HAUPTMAN HAM & BERNER, LLP, 1700 DIAGONAL ROAD, SUITE 300, ALEXANDRIA, VA, 22314, US

(73) Assignee: TPO DISPLAYS CORP., Miao-Li County (TW)

(21) Appl. No.: 12/568,028

(22) Filed: Sep. 28, 2009

(30) Foreign Application Priority Data
Sep. 29, 2008 (JP) 2008-251069

(51) Int. Cl. G02F 1/1343; G02F 1/13

(52) U.S. Cl. 349/139; 349/187

(57) ABSTRACT

A liquid crystal display device and a manufacturing method thereof are provided. The device includes a first substrate; a first pixel having a first pixel electrode deposed on the first substrate; a second pixel having a second pixel electrode deposed on the first substrate, wherein the first and second pixels are adjacent; a second substrate deposed on the opposite side of the first substrate; a liquid crystal layer including a plurality of first and second liquid crystal molecules, deposed between the first and second substrates; a first common electrode and a second common electrode deposed on the second substrate, respectively opposite to the first and second pixel electrodes; a first pattern deposed on the first common electrode; and a second pattern deposed on the second common electrode; wherein the second pattern causes the second liquid crystal molecules corresponding to the second pixel electrode aligned asymmetrically.

### CROSS REFERENCE TO RELATED APPLICATIONS

This application claims the benefit of Japan Application No. 2008-251069, filed Sep. 29, 2008.

### BACKGROUND OF THE INVENTION

1. Field of the Invention

The present invention relates to a liquid crystal display device and the manufacturing method thereof, and in particular relates to a liquid crystal display device for performing a bi-directional image display.

2. Description of the Related Art

A liquid crystal display (LCD) device is constituted by two transparent substrates and liquid crystal molecules between, where pixel electrodes are matrix arranged on one transparent substrate and common electrodes are formed on the other transparent substrate opposite to each pixel electrode. The LCD device performs various displays by controlling the alignment of the liquid crystal molecules through applying driven voltages between the pixel electrodes and the common electrodes.

FIG. 9 shows a relationship of view angles and picture brightness of conventional LCD devices, i.e. view angle characteristics. FIG. 10 is a schematic view illustrating the view angle characteristics of conventional LCD devices.

As shown in FIG. 9, the brightest image is from the vertical direction of the picture, i.e. 0° of the view angle, in the conventional LCD device 2, and the brightness gradually decreases following the increasing of the absolute view angles apart from the vertical direction of the image.

In a consequent, people see the brightest image from the real front side of the picture and a darker image from the left or right side of the picture depending on view angles, as shown in FIG. 10.

Additionally, pixels of a picture are classified into two groups: the first pixel group and the second pixel group, in a LCD device. The first and second pixel groups respectively display the first and second images. The first image is viewed from the left side of the picture, and the second image is viewed from the right side of the pictures, which constitutes a bi-directional image display to form a dual view display device.

A dual view display device can display different images simultaneously. As it is applied to in-vehicle display devices, such as car navigation system display devices, which is usually deposed in the center of the instrument panel, it shows, for instance, a map image to the driver side and a television to the passenger side.

Conventional dual view display device are constituted by, for example, pixels of the first pixel group and pixels of the second pixel group in an arrangement of a vertical and horizontal alternation. To perform a bi-directional image display, a latticed viewing angle control barrier is posed in front of the picture corresponding to the configuration of the pixels so that only the pixels of the first pixel group are visible from the left side of the picture where the pixels of the second pixel group are sheltered; and only the pixels of the second pixel group are visible from the right side of the picture where the pixels of the first pixel group are sheltered.

In another example, conventional dual view display devices are constituted by pixel rows of the first pixel group and pixel rows of the second pixel group in an arrangement of a horizontal alternation. To perform a bi-directional image display, a strip viewing angle control barrier is deposed in front of the picture corresponding to the configuration of the pixels so that only the pixel rows of the first pixel group are visible from the left side of the picture where the pixel rows of the second pixel group are sheltered; and only the pixel rows of the second pixel group are visible from the right side of the picture where the pixel rows of the first pixel group are sheltered.

Regardless of the constitution, conventional dual view display devices must have a viewing angle control barrier which needs to precisely arrange the position corresponding to the configuration of the pixels.

The first and second pixels groups of conventional dual view display devices respectively display distinct images by controlling driven voltages applying to the pixel electrodes of the pixels of each pixel groups, but the structure of the pixel, either the first pixel group or second pixel group, is exactly the same.

FIG. 11 is a schematic view for a first example showing the pixel (FIG. 11(a)) of the first pixel group and the pixel (FIG. 11(b)) of the second pixel group in a conventional dual view display device.

In the first example shown in FIGS. 11 (a) and (b), an alignment layer in a region of the pixel 71 of the first pixel group or the pixel 72 of the second pixel group on one of the transparent substrates is under the same rubbing and forms a predetermined alignment of the liquid crystal molecules. Through controlling driven voltages applied to the pixel electrodes and changing the alignment of the liquid crystal molecules, the first pixel group and the second pixel group can respectively display distinct images.

However, the rubbing is difficult in precise performance and improvement of the product quality. For this reason, a pattern, such as a protrusion or opening, formed in the center of the common electrode opposite to the pixel electrode is taken in place of an alignment layer with rubbing.

FIG. 12 is a plane view showing a second example of the pixel (FIG. 12(a)) of the first pixel group and the pixel (FIG. 12(b)) of the second pixel group in a conventional dual view display device.

In the second example shown in FIGS. 12 (a) and (b), a pattern 301 or 302 is formed in the center of the common electrode opposite to each pixel electrode in the pixel 81 of the first pixel group or the pixel 82 of the second pixel group.

FIG. 13 is a sectional view illustrating the first sectional structure (FIG. 13(a)) and the second sectional structure (FIG. 13(b)) of the pixels of the first and second pixel groups in the second example of a conventional dual view display device.

The first and second sectional structures, shown in FIGS. 13 (a) and (b), have a pixel electrode 411 on a transparent substrate 401 and a common electrode 412 opposite to the pixel electrode 411 on another transparent substrate 402 opposite to the transparent substrate 401.

In the first sectional structure shown in FIG. 13(a), a pattern formed in the center of the common electrode 412 is a protrusion 303a.

In the second sectional structure shown in FIG. 13(b), a pattern formed in the center of the common electrode 412 is an opening 303b.

Corresponding to FIG. 12, the patterns 301, 302 usually both are protrusions 303a or openings 303b.

Accordingly, the protrusion 303a or opening 303b is formed in the center of the common electrode 412 opposite to the pixel electrode 411. In the plane view of FIG. 12, the liquid crystal molecules in the surrounding of the protrusion 303a or opening 303b are aligned in a vertical and horizontal symmetry.

In the structure above, when the alignment of the liquid crystal molecules which is in a vertical and horizontal symmetry in the surroundings of the protrusion 303a or opening 303b is changed by controlling the driven voltage applied to the pixel electrode 411, the first and second pixel groups respectively display distinct images.

The structure of the protrusion 303a or opening 303b in the center of the common electrode 412 is easier to improve the product quality and manufacture precisely than that of alignment layers with rubbing.

Although a conventional dual view display device performs a dual view, the pixels of the first and second pixel groups are exactly the same. The pixel of a conventional dual view display device completely equals to that of a conventional LCD device.

Therefore, the view angle characteristics of the image of the first pixel group and the image of the second pixel groups in conventional dual view display devices are like those in conventional LCD devices.

FIG. 14 shows a relationship of view angles and picture brightness of conventional dual view display devices 3, i.e. view angle characteristics. FIG. 15 is a schematic view illustrating the view angle characteristics of conventional dual view display devices.

As shown in FIG. 14, conventional dual view display devices have the pixel of the first pixel group and that of second pixel group and a viewing angle control barrier deposed in the front of the picture, which cause that the brightest image is from the vertical direction of the picture and the brightness gradually decreases following the increasing of the absolute view angles apart from the vertical direction of the image, like the visual angle characteristics shown in FIG. 9.

The visual angle characteristics are the same either for the structure with an alignment layer with rubbing or the structure with a pattern in the center of the common electrode opposite to the pixel electrode.

Therefore, conventional dual view display devices must have a viewing angle control barrier in a precise position corresponding to the configuration of the pixel.

In addition, a known technique has proposed a plan display device using a prism sheet to form slightly brighter images from the left and right view directions (for example, Japan Patent Application 2001-195913).

However, when the viewing angle control barrier in a conventional dual view display device is slightly oblique, one or both of the first image of the first pixel group and the second image of the second pixel group becomes unclear, or two images mix leading to one or both of the images difficult to watch.

Even if conventional dual view display devices adopt a pattern formed in the center of the common electrode opposite to each pixel electrode, instead of alignment layers with rubbing, the viewing angle control barrier is still an essential element and it is still difficult to improve the product quality.

In addition, the conventional LCD of a conventional dual view display device completely equal to the LCD of the conventional LCD device shown in FIG. 9, except for viewing angle control barriers, assuming that the visual angle characteristics of the conventional LCD device is the same with FIG. 14.

Accordingly, as shown in FIGS. 14 and 15, the first image of the first pixel group viewed from the left side of the picture and the second image of the second pixel group viewed from the right side of the picture show less than 60-70% of the brightness, compared to the image viewed from the vertical direction of the picture, which cause a dark and uneasily visible image.

Especially when dual view display devices are applied to in-vehicle display devices, such as car navigation system display device, clear images are required in order to immediately recognize the display information.

### BRIEF SUMMARY OF THE INVENTION

A detailed description is given in the following embodiments with reference to the accompanying drawings.

According to the invention provides a liquid crystal display device, including a first substrate; a first pixel having a first pixel electrode, deposed on the first substrate; a second pixel having a second pixel electrode, deposed on the first substrate, wherein the first pixel and second pixel are adjacent; a second substrate, deposed on the opposite side of the first substrate; a liquid crystal layer, comprising a plurality of first liquid crystal molecules and second liquid crystal molecules, deposed between the first and second substrates; a first common electrode and a second common electrode deposed on the second substrate, respectively opposite to the first and second pixel electrodes; a first pattern, deposed on the first common electrode; and a second pattern, deposed on the second common electrode; wherein the second pattern causes the second liquid crystal molecules corresponding to the second pixel electrode aligned asymmetrically.

According to the invention further provides an electronic device, comprising the liquid crystal display device described above.

According to the invention provides a method of manufacturing a liquid crystal display device, including: providing a first substrate; forming a first pixel electrode of a first pixel and a second pixel electrode of a second pixel on the first substrate, wherein the first pixel and second pixel are adjacent; providing a second substrate on the opposite side of the first substrate; disposing a liquid crystal layer between the first and second substrates, wherein the liquid crystal layer comprises a plurality of first liquid crystal molecules and second crystal molecules; forming a first common electrode and a second common electrode on the second substrate, respectively opposite to the first pixel electrode and the second pixel electrode; forming a first pattern on the first common electrode; and forming a second pattern on the second common electrode; wherein the second pattern causes the second liquid crystal molecules corresponding to the second pixel electrode aligned asymmetrically.

Therefore, the invention provides a liquid crystal display device and manufacturing method thereof for performing a bi-directional image display with an improvement of the product quality.

### BRIEF DESCRIPTION OF THE DRAWINGS

The present invention can be more fully understood by reading the subsequent detailed description and examples with references made to the accompanying drawings, wherein:

FIG. 1 is a plane view illustrating the constitution of the first pixel of the first pixel group and the second pixel of the second pixel group in the first embodiment according to the invention, where FIG. 1(a) illustrates the first pixel and FIG. 1(b) illustrates the second pixel;

FIG. 2 is a graph illustrating the visual angle characteristics of the first pixel of the first pixel group and the second pixel of the second pixel group in the first embodiment according to the invention;

FIG. 3 is a schematic view illustrating the visual angle characteristics of the first pixel of the first pixel group and the second pixel of the second pixel group in the first embodiment according to the invention;

FIG. 4 is a plane view illustrating the constitution of the first pixel of the first pixel group and the second pixel of the second pixel group in the second embodiment according to the invention, where FIG. 4(a) illustrates the first pixel and FIG. 4(b) illustrates the second pixel;

FIG. 5 is a graph illustrating the visual angle characteristics of the first pixel of the first pixel group and the second pixel of the second pixel group in the second embodiment according to the invention;

FIG. 6 is an exemplary plane view illustrating various patterns formed by the pattern of the first pixel of the first pixel group and the second pixel of the second pixel group in the first and second embodiments according to the invention, where FIG. 6(a) illustrates the pattern of the pixel in a vertical and horizontal symmetry, FIG. 6(b) and FIG. 6(c) illustrate the pattern of the pixel in a horizontal asymmetry, and FIG. 6(d) and FIG. 6(e) illustrate the pattern of the pixel in a vertical asymmetry;

FIG. 7 is a plane view illustrating the first arrangement of the first and second pixels in the first and second embodiments according to the invention;

FIG. 8 is a plane view illustrating the second, third and fourth arrangements of the first and second pixels in the first and second embodiments according to the invention, where FIG. 8(a) illustrates the pixels in the second arrangement, FIG. 8(b) illustrates the pixels in the third arrangement, and FIG. 8(c) illustrates the pixels in the fourth arrangement;

FIG. 9 is a graph illustrating the visual angle characteristics of conventional LCD devices;

FIG. 10 is a schematic view illustrating the visual angle characteristics of conventional LCD devices;

FIG. 11 is a schematic view illustrating the pixel of the first pixel group and the pixel of the second pixel group in the first example of a conventional dual view display device, where FIG. 11(a) illustrates the pixel of the first pixel group and FIG. 11(b) illustrates the pixel of the second pixel group;

FIG. 12 is a schematic view illustrating the pixel of the first pixel group and the pixel of the second pixel group in the second example of a conventional dual view display device, where FIG. 12(a) illustrates the pixel of the first pixel group and FIG. 12(b) illustrates the pixel of the second pixel group ;

FIG. 13 is a sectional view showing the first sectional structure and the second sectional structure of the pixels of the first and second pixel groups in the second example of a conventional dual view display device, where FIG. 13(a) illustrates the first sectional structure of the pixel and FIG. 13(b) illustrates the second sectional structure of the pixel;

FIG. 14 is a graph illustrating the visual angle characteristics of the pixels of the first and second pixel groups in a conventional dual view display device; and

FIG. 15 is a schematic view illustrating the visual angle characteristics of pixels of the first and second pixel groups in a conventional dual view display device.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

The liquid crystal display (LCD) device manufactured by the method according to the invention, i.e. the LCD device according to the invention, comprises a pattern, such as a protrusion or opening, formed in the region of the common electrode opposite to each pixel electrodes for aligning the liquid crystal molecules. One or both of the patterns on the pixel of the first pixel group displaying the first image and the pixel of the second pixel group displaying the second image causes the liquid crystal molecules in the pixels aligned in a vertical or horizontal asymmetry with different constitutions.

Therefore, it is possible to increase the brightness of the images displayed respectively by the first pixel group and second pixel group at the predetermined view angles by adequately designing vertically or horizontally asymmetrical configuration of the patterns.

The embodiments according to the invention for LCD devices and the manufacturing methods thereof are described with figures as below.

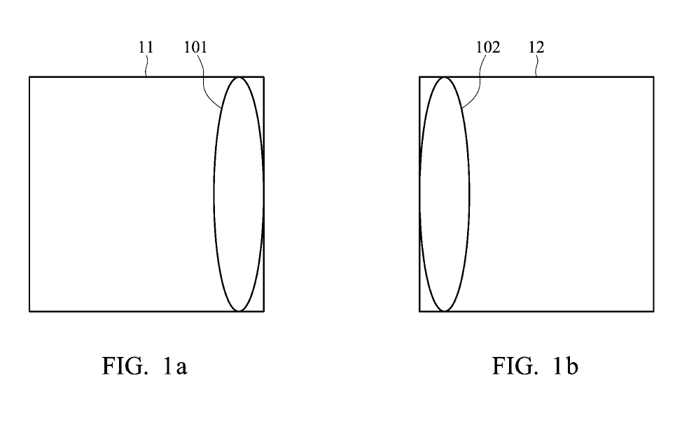

FIG. 1 is a plane view illustrating the LCD manufactured by the method of the first embodiment according to the invention, including the first pixel 11 of the first pixel group displaying the first image and the second pixel 12 of the second pixel group displaying the second image, wherein the first pixel 11 and second pixel 12 are adjacent.

In the first embodiment according to the invention, as shown in FIG. 1(a), a pattern 101 is formed between the right side and the center of the pixel or along the right side of the pixel in the region of the common electrode opposite to the pixel electrode of the first pixel 11. As shown in FIG. 1(b), a pattern 102 is formed between the left side and the center of the pixel or along the left side of the pixel in the region of the common electrode opposite to the pixel electrode of the second pixel 12. The pattern 101 is formed along the right side of the pixel 11 and the pattern 102 is formed along the left side of the pixel 12, in which the patterns 101 and 102 are protrusions or openings.

The common electrode is commonly a transparent electrode formed by indium tin oxide (ITO).

Additionally, when the pattern 101 is a protrusion, the protrusion 101 is commonly insulating materials. The protrusion 101 may be transparent insulating materials for the light penetration concern.

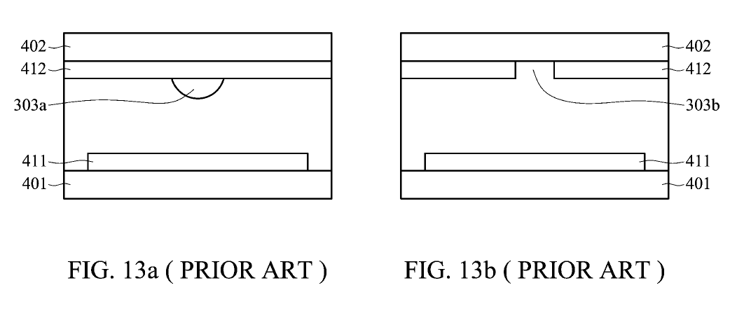

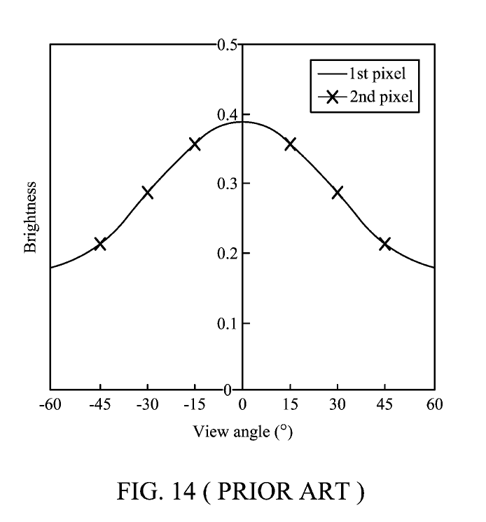

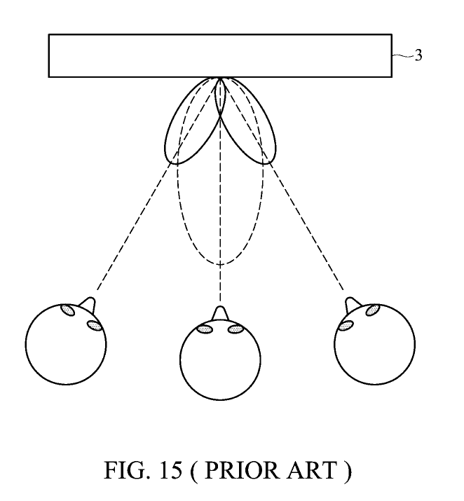

In the first embodiment according to the invention, the sectional structure of the first pixel 11 of the first pixel group or the second pixel 12 of the second pixel group equals to the sectional structure of FIG. 13(a) or FIG. 13(b), except the shapes and the positions of the patterns 101 and 102.

That is, each the first pixel 11 and the second pixel 12 comprises: a first transparent substrate 401, a pixel electrode 411 on the first transparent substrate 401, a second transparent substrate 402 on the opposite side of the first transparent substrate 401, a common electrode 412 on the second transparent substrate 402 opposite to the pixel electrode 411, and a liquid crystal layer deposed between the first transparent substrate 401 and second transparent substrate 402, wherein the liquid crystal layer comprises a plurality of liquid crystal molecules.

In case that the LCD device has color filters, the color filters are formed between the second transparent substrate 402 and the common electrode 412.

As shown in the plane view of FIG. 1, the liquid crystal molecules on the left side of the pattern 101 are aligned toward one end and those on the right side of the pattern 102 are aligned toward another end.

That is, in the first embodiment according to the invention, the first pixel 11 of the first pixel group and the second pixel 12 of the second pixel group respectfully comprise the liquid crystal molecules aligned in a horizontal asymmetry. The liquid crystal molecules of the first pixel 11 are aligned toward the right of the axis of the plane view, and the liquid crystal molecules of the second pixel 12 are aligned toward the left of the axis of the plane view.

The patterns 101 and 102 are vertically symmetric on the transverse axle of the plane view of the first pixel 11 and the second pixel 12 so that the alignment of the liquid crystal molecules is also vertically symmetric.

Therefore, in the first embodiment according to the invention, the first pixel 11 of the first pixel group and the second pixel 12 of the second pixel group are arranged in a vertical-and-horizontal alternation or a horizontal alternation. Specifically, the first pixel 11 and the second pixel 12 are arranged in a chessboard-like lattice or alternative line.

In the first embodiment according to the invention, the first pixel group and the second pixel group display respectively the first image and the second image by controlling driven voltages applied to the pixel electrodes for aligning liquid crystal molecules in a horizontal asymmetry in the surroundings of the pattern 101 of the first pixel 11 and the pattern 102 of the second pixel 12. The first and second images may be different or the same.

As described above, in place of alignment layers with rubbing, the structure of the patterns 101 or 102 formed in the region of the common electrode 412 opposite to the pixel electrode 411 is easier to improve the product quality and manufacture precisely.

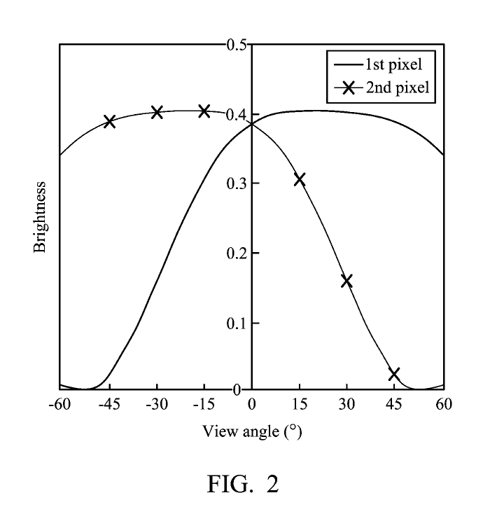

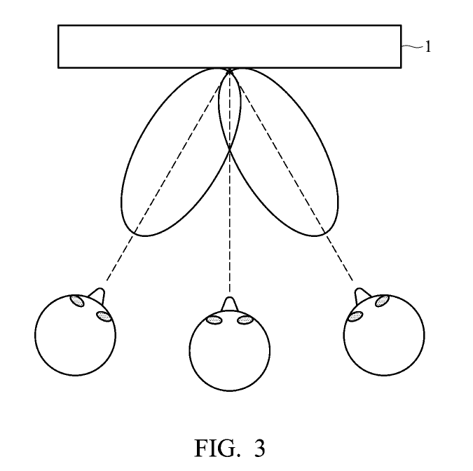

FIG. 2 is a graph illustrating the relationship of view angles and the brightness of the image, i.e. visual angle characteristics, of the first pixel 11 of the first pixel group and the second pixel 12 of the second pixel group in the first embodiment according to the invention. FIG. 3 is a schematic view illustrating the visual angle characteristics of the first pixel 11 of the first pixel group and the second pixel 12 of the second pixel group in the first embodiment according to the invention.

In the first embodiment according to the invention, because liquid crystal molecules in the pattern 101 formed between the right side and the center of the first pixel 11 or along the right side of the first pixel 11 and in the pattern 102 formed between the left side and the center of the second pixel 12 or along the left side of the second pixel 12 are each aligned in a horizontal asymmetry toward different ends, the brightest first image of the first pixel of the first pixel group is from 30° of the view angle right of the vertical direction of the picture (+30°); and the brightest second image of the second pixel of the second pixel group is from 30° of the view angle left of the vertical direction of the picture (−30°), as shown in FIG. 2.

On the contrary, the first image from −30° of the view angle and the second image from +30° of the view angle show very low brightness and are almost invisible.

Therefore, in the LCD device 1 of the first embodiment according to the invention, as shown in FIG. 3, the first image is clear but the second image is almost invisible from 30° right, i.e. +30° of the view angle; and the second image is clear but the first image is almost invisible from 30° left, i.e. −30° of the view angle.

Based on the visual angle characteristics shown in FIG. 2, the first image is quite clear from 30°±15° right, i.e. +30°±15° of the view angle; and the second image is quite clear from 30°±15° left, i.e. −30°±15° of the view angle.

Since the second image from 30°±15° right, i.e. +30°±15° of the view angle and the first image from 30°±15° left, i.e. −30°±15° of the view angle are almost invisible according the visual angle characteristics of the LCD elements, the viewing angle control barrier, the essential element of the conventional dual view display device, is not required in the LCD device of the first embodiment according to the invention. Therefore, a step of precisely posing the viewing angle control barrier correspondent to the configuration of the pixel is not required in the method of manufacturing the LCD device according to the first embodiment of the invention.

Therefore, the LCD device of the first embodiment according to the invention and the manufacturing method thereof provide a LCD device with two distinct clear images viewing from two directions with large improvement of the product quality.

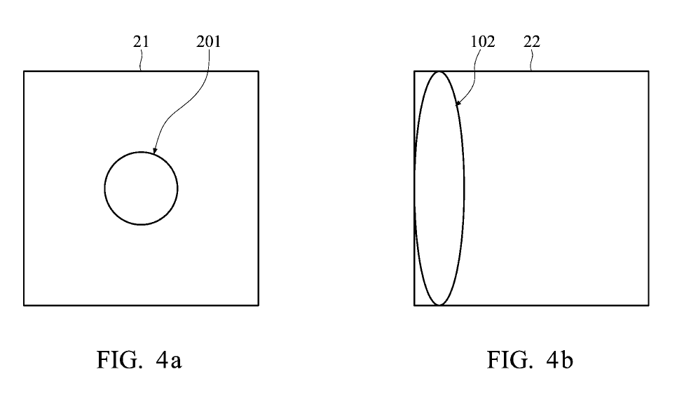

FIG. 4 is a plane view showing the LCD manufactured by the method of the second embodiment according to the invention, including the first pixel 21 of the first pixel group displaying the first image and the second pixel 22 of the second pixel group displaying the second image, wherein the first pixel 21 has a pattern 201 and the second pixel 22 has a pattern 102.

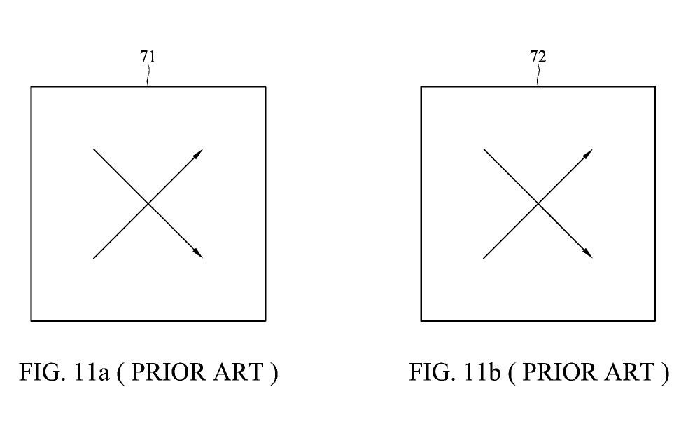

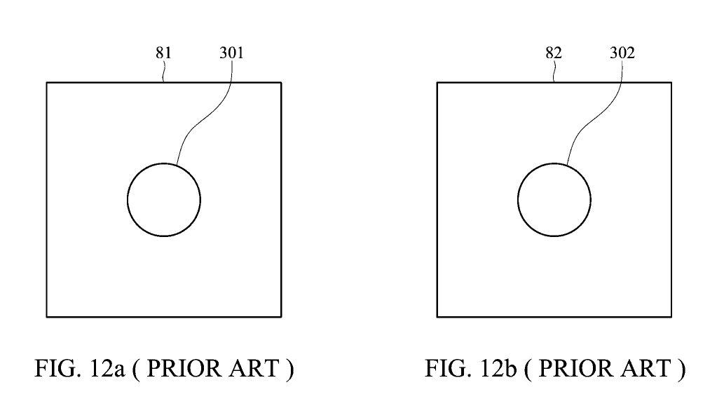

The difference between the first embodiment and second embodiment according to the invention is the constitution of the first pixel 21 in the second embodiment. In FIG. 4(a), a pattern 201 formed in the center of the common electrode opposite to the pixel electrode of the first pixel 21 causes the liquid crystal molecules aligned in a vertical and horizontal symmetry, the same with FIG. 12(a).

Therefore, in the plane view of FIG. 4, liquid crystal molecules in the first pixel 21 of the first pixel group are aligned in a vertical and horizontal symmetry; and those in the second pixel 22 of the second pixel group are aligned in a horizontal asymmetry on the left of the axis of the plane view.

The pattern 201 of the first pixel 21 and the pattern 102 of the second pixel 22 are respectfully vertically symmetric on the basis of the transverse axle of the plane view so that alignment of the liquid crystal molecules is also vertical symmetry.

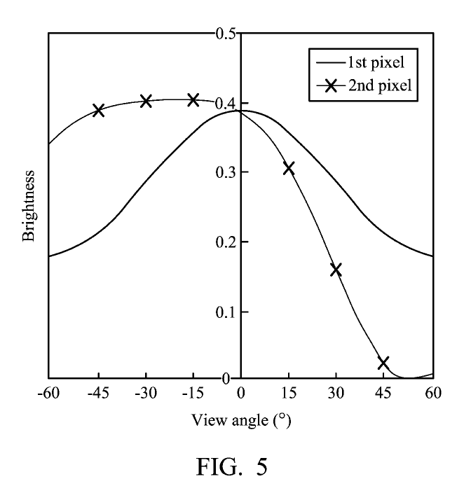

FIG. 5 shows the relationship of view angles and the brightness of the image, i.e. visual angle characteristics, of the first pixel 21 of the first pixel group and the second pixel 22 of the second pixel group in the second embodiment according to the invention.

In the second embodiment according to the invention, because the pattern 102 is formed between the left side and the center of the second pixel 22 or along the left side of the second pixel 22, the liquid crystal molecules are aligned in a horizontal asymmetry toward one end. Thus, the brightest second image of the second pixels of the second pixel group is from 30° of view angle left of the vertical direction of the image (−30°) on the basis of the axle of the plane view, as shown in FIG. 5.

In addition, because the pattern 201 is formed in a vertical and horizontal symmetry in the center of the first pixel 21, the liquid crystal molecules are aligned in a vertical and horizontal symmetry toward one end. Thus, the brightest first image of the first pixels of the first pixel group is from the vertical direction of the picture, i.e. 0° of view angle, and the brightness gradually decreases following the increasing of absolute view angles apart from the vertical direction of the image.

Therefore, people can watch a clear first image from 0° of view angle and a clear second image from 30° left, i.e. −30° of view angle, on the basis of the vertical direction of the image, displayed by the LCD device of the second embodiment according to the invention.

According to the view angle characteristics shown in FIG. 5, the first image is clear from 0°±15° of view angle; and the second image is clear from 30°±15° left, i.e. −30°±15° of view angle.

Therefore, in the second embodiment according to the invention, the first image possibly overlaps the second image depending on the view angles, but it is exemplary that the first image is clear from the real front side of the picture and the second image is clear from the left side of the picture.

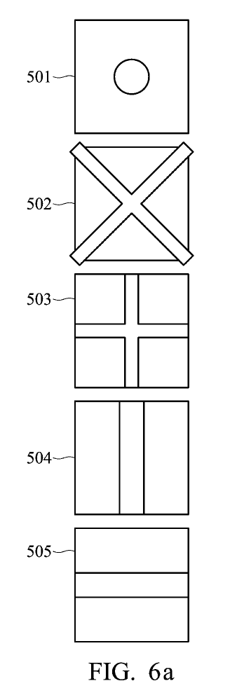

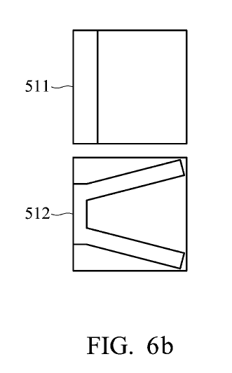

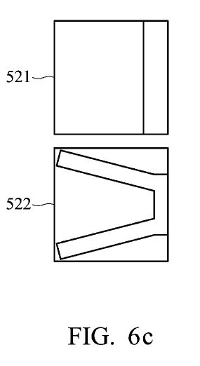

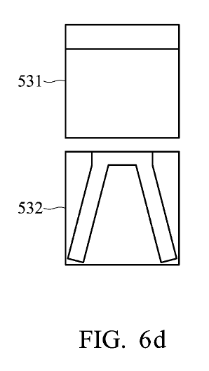

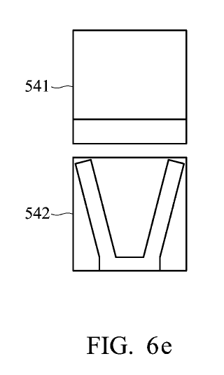

FIG. 6 is an exemplary plane view illustrating various patterns of the first pixel of the first pixel group and the second pixel of the second pixel group in the first and second embodiments according to the invention.

The pattern 201 of the first pixel in the second embodiment according to the invention is in a vertical and horizontal symmetry, which may configure various patterns, such as a circle pattern 501, a diagonal or X-like pattern 502, a vertical and horizontal centerline-like or Cross-like pattern 503, a vertical centerline-like or I-like pattern 504, and a horizontal centerline-like or bar-like pattern 505, as shown in FIG. 6(a).

The pattern 102 of the second pixel 102 in the second embodiment according to the invention is either a I-like pattern 511 formed between the middle and the left side of the pixel or along with the left side of the pixel, or a “transverse U-like” pattern 512 comprising a basic part that forms proximity to or along with the middle of the longitude of the region between the left side and the center of the pixels and two additional parts that each forms an obtuse angle with the basic part toward two ends of the pixel, as shown in FIG. 6(b).

Regarding to the I-like pattern 511 formed along with the left side of the pixel, one of the patterns shown in FIG. 6(b), as the liquid crystal molecules proximity to the boundary are aligned toward one end, the force of the liquid crystal molecules moving along the direction of the pattern 511 almost equals to the force along the direction of the top or bottom of the pixel so that the alignment is not in chorus leading to a chaotic alignment status.

To prevent from the chaotic alignment of the liquid crystal molecules, the “transverse U-like” pattern 512 becomes an effective strategy.

The pattern 101 of the first pixel 11 in the first embodiments according to the invention is either a I-like pattern 521 formed between the middle and right side of the pixel or along with the right side of the pixel, or a “transverse U-like” pattern 522 comprising a basic part that forms proximity to or along with the middle of the longitude of the region between the right side and the center of the pixels and two additional parts that each forms an obtuse angle with the basic part toward two ends of the pixel as shown in FIG. 6 (c).

Alternatively, the pattern of the pixel in the first and second embodiments according to the invention can cause the liquid crystal molecules aligned in a vertical asymmetry, including either a bar-like pattern 531 formed between the middle and the top of the pixel or along with the top of the pixel, or a “transverse U-like” pattern 532 comprising a basic part that forms proximity to or along with the middle of the latitude of the region between the top and the center of the pixels and two additional parts that each forms an obtuse angle with the basic part toward two ends of the pixel, as shown in FIG. 6(d).

Similarly, the pattern causes the liquid crystal molecules aligned in a vertical asymmetry, including either a bar-like pattern 541 formed between the middle and the bottom of the pixel or along with the bottom of the pixel, or a “transverse U-like” pattern 542 comprising a basic part that forms proximity to or along with the middle of the latitude of the region between the bottom and the center of the pixels and two additional parts that each forms an obtuse angle with the basic part toward two ends of the pixel, as shown in FIG. 6(e).

For example, when the first pixel of the first pixel group and the second pixel of the second pixel group with the patterns in a vertical asymmetry as shown in FIG. 6(d) and FIG. 6(e) are arranged in a vertical alternation, it can be predicted that the images change alternatively by vertically moving view angles.

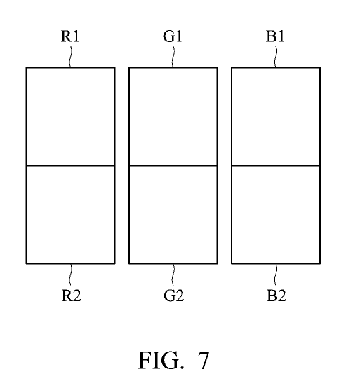

FIG. 7 is a plane view showing a first arrangement of the first and second pixels in the first and second embodiments according to the invention.

The first arrangement shown in FIG. 7 illustrates an exemplary pixel consisted of three sub pixels as a set.

The first pixel consists of the first red sub pixel R1, the first green sub pixel G1 and the first blue sub pixel B1. Each of the first red sub pixel R1, the first green sub pixel G1 and the first blue sub pixel B1 has the same constitution with the first pixel of the first and second embodiment according to the invention.

The second pixel consists of the second red sub pixel R2, the second green sub pixel G2 and the second blue sub pixel B2. Each of the second red sub pixel R2, the second green sub pixel G2 and the second blue sub pixel B2 has the same constitution with the second pixel of the first and second embodiment according to the invention.

The first pixel consists of the first red sub pixel R1, the first green sub pixel G1 and the first blue sub pixel B1 and the second pixel consists of the second red sub pixel R2, the second green sub pixel G2 and the second blue sub pixel B2 become a unit of a image. Although the vertical and horizontal arrangements need to consider, the first and second pixels above are corresponding to those of the first and second embodiments according to the invention.

Accordingly, the first arrangement of FIG. 7 arranges the first and second pixels of the first and second pixel groups in a vertical alternation. It can be predicted that the images change alternatively by vertically moving view angles.

In addition, when the first arrangement of FIG. 7 is rotated counter clockwise 90° and the first and second pixels above are corresponding to those of the first and second embodiments according to the invention, the first and second pixels of the first and second pixel groups are arranged in a horizontal alternation, which the images change alternatively by horizontally moving view angles.

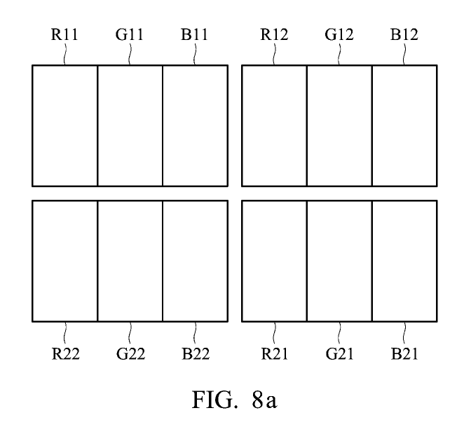

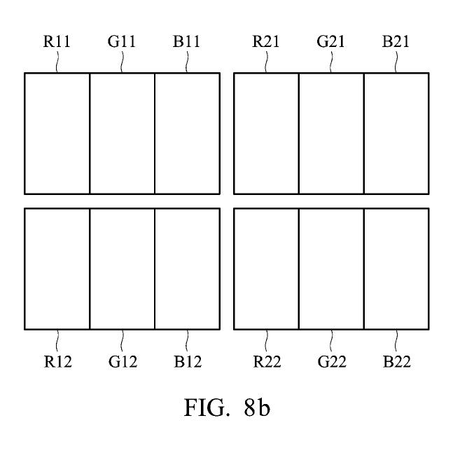

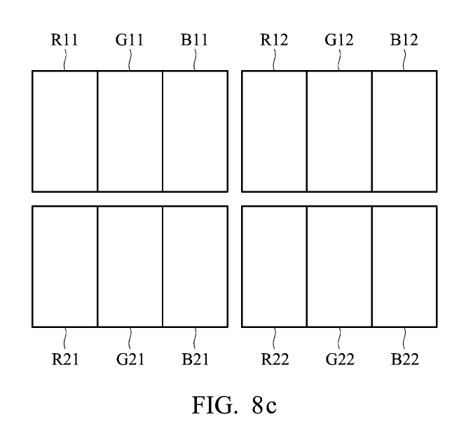

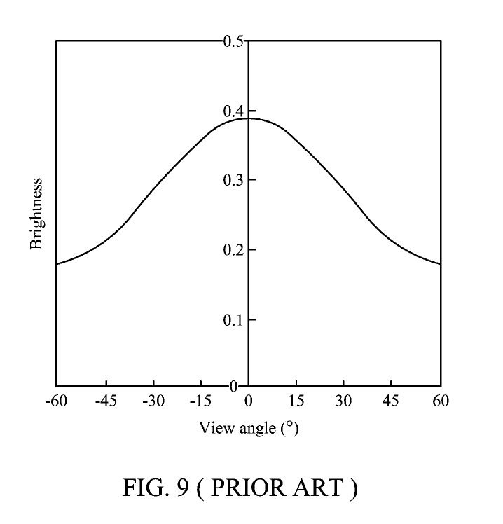

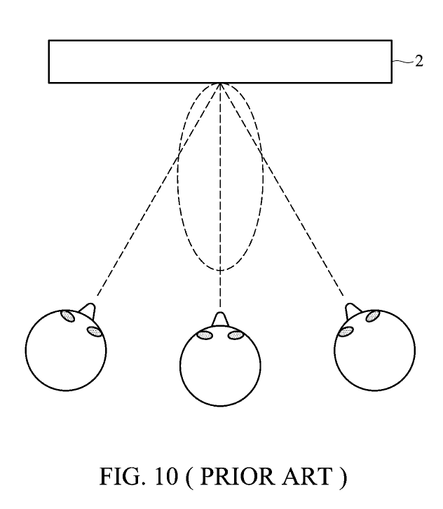

FIG. 8 is a plane view showing the second, third and fourth arrangements of the first and second pixels in the first and second embodiments according to the invention.

The second, third and fourth arrangements respectively shown in FIG. 8(a), FIG. 8(b) and FIG. 8(c) illustrates an exemplary pixel set consisted of three sub pixels as a set.

In the second, third and fourth arrangements of FIG. 8(a), FIG. 8(b) and FIG. 8(c), the first pixel set consists of the first red sub pixel R11, the first green sub pixel G11 and the first blue sub pixel B11. Each of the first red sub pixel R11, the first green sub pixel G11 and the first blue sub pixel B11 has the same constitution with the first pixel of the first and second embodiment according to the invention.

The second pixel set consists of the second red sub pixel R12, the second green sub pixel G12 and the second blue sub pixel B12. Each of the second red sub pixel R12, the second green sub pixel G12 and the second blue sub pixel B12 has the same constitution with the second pixel of the first and second embodiment according to the invention.

The third pixel set consists of the third red sub pixel R21, the third green sub pixel G21 and the third blue sub pixel B21. Each of the third red sub pixel R21, the third green sub pixel G21 and the third blue sub pixel B21 has the same constitution with the first pixel of the first and second embodiment according to the invention.

The fourth pixel set consists of the fourth red sub pixel R22, the fourth green sub pixel G22 and the fourth blue sub pixel B22. Each of the fourth red sub pixel R22, the fourth green sub pixel G22 and the fourth blue sub pixel B22 has the same constitution with the second pixel of the first and second embodiment according to the invention.

Each of the first pixel set, the second pixel set, the third pixel set and the fourth pixel set becomes a unit of the image.

In the second arrangement of FIG. 8(a), the first and third pixel sets corresponding to the first pixels of the first and second embodiments according to the invention and the second and fourth pixel sets corresponding to the second pixels of the first and second embodiments according to the invention are arranged in a vertical and horizontal alternation.

As the pixels in the second arrangement of FIG. 8(a) comprise a constitution of the liquid crystal molecules aligned in vertical symmetry and horizontal asymmetry, it can be predicted that the images change alternatively by horizontally moving view angles.

As the pixels in the second arrangement of FIG. 8(a) comprise a constitution of the liquid crystal molecules aligned in vertical asymmetry and horizontal symmetry, it can be predicted that the images change alternatively by vertically moving view angles.

In the third arrangement as shown in FIG. 8(b), the pixels consist of the first and third pixel sets corresponding to the first pixels of the first and second embodiments according to the invention are arranged in a row, and the pixels consist of the second and fourth pixel sets corresponding to the second pixels of the first or second embodiment according to the invention are arranged in a row. The row of the first and third pixel sets and that of the second and fourth pixel sets are arranged in a vertical alternation.

As the pixels in the third arrangement of FIG. 8(b) comprise a constitution of the liquid crystal molecules aligned in vertical symmetry and horizontal asymmetry, it can be predicted that the images change alternatively by horizontally moving view angles.

As the pixels in the third arrangement of FIG. 8(b) comprise a constitution of the liquid crystal molecules aligned in vertical asymmetry and horizontal symmetry, it can be predicted that the images change alternatively by vertically moving view angles.

In the fourth arrangement of FIG. 8(c), the first and third pixel sets corresponding to the first pixels of the first and second embodiments according to the invention are arranged in a line, and the second and fourth pixel sets corresponding to the second pixels of the first or second embodiment according to the invention are arranged in a line. The line of the first and third pixel sets and that of the second and fourth pixel sets are arranged in a horizontal alternation.

As the pixels in the fourth arrangement of FIG. 8(c) comprise a constitution of the liquid crystal molecules aligned in vertical symmetry and horizontal asymmetry, it can be predicted that the images change alternatively by horizontally moving view angles.

As the pixels in the fourth arrangement of FIG. 8(c) comprise a constitution of the liquid crystal molecules aligned in vertical asymmetry and horizontal symmetry, it can be predicted that the images change alternatively by vertically moving view angles.

Accordingly, as the configuration of the patterns on the first and second pixels of the first and second embodiments according to the invention and the arrangements of the first and second pixels are changed, various constitution of LCD devices for performing a bi-directional image display can be achieved.

The liquid crystal display device manufactured by the method according to the invention, i.e. the LCD device according to the invention, may be applied to in-vehicle display devices, such as car navigation system display device, but not limited thereto. The liquid crystal display device according to the invention may be applied to all kinds of electronic devices, such as mobile phone devices, digital cameras, personal digital assistants (PDA), portable computers, desktop computers, television receivers, portable DVD players, or portable blue-disc players.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A liquid crystal display device, comprising
a first substrate;
a first pixel having a first pixel electrode, deposed on the first substrate;
a second pixel having a second pixel electrode, deposed on the first substrate,
wherein the first pixel and the second pixel are adjacent;
a second substrate, deposed on the opposite side of the first substrate;
a liquid crystal layer, comprising a plurality of first liquid crystal molecules and second liquid crystal molecules, deposed between the first and second substrates;
a first common electrode and a second common electrode, deposed on the second substrate, respectively opposite to the first and second pixel electrodes;
a first pattern, deposed on the first common electrode; and
a second pattern, deposed on the second common electrode;
wherein the second pattern causes the second liquid crystal molecules corresponding to the second pixel electrode aligned asymmetrically.

2. The liquid crystal display device as claimed in claim 1, wherein the second liquid crystal molecules are aligned in vertical symmetry and horizontal asymmetry.

3. The liquid crystal display device as claimed in claim 1, wherein the second liquid crystal molecules is aligned in horizontal symmetry and vertical asymmetry.

4. The liquid crystal display device as claimed in claim 1, wherein the first pattern causes the first liquid crystal molecules corresponding to the first pixel electrode aligned in a vertical and horizontal symmetry.

5. The liquid crystal display device as claimed in claim 1, wherein the first pattern causes the first liquid crystal molecules corresponding to the first pixel electrode aligned asymmetrically.

6. The liquid crystal display device as claimed in claim 5, wherein the first liquid crystal molecules are aligned in vertical symmetry and horizontal asymmetry.

7. The liquid crystal display device as claimed in claim 5, wherein the first liquid crystal molecules are aligned in horizontal symmetry and vertical asymmetry.

8. The liquid crystal display device as claimed in claim 1, wherein the first pattern contains a basic part deposed on right side of the first common electrode, and the second pattern contains a basic part deposed on left side of the second common electrode.

9. The liquid crystal display device as claimed in claim 8, wherein the first pattern further comprises two additional parts toward a direction of an obtuse angle with ends of the basic part, and the second pattern further comprises two additional parts toward a direction of an obtuse angle with ends of the basic part.

10. The liquid crystal display device as claimed in claim 1, wherein the first pattern contains a basic part deposed on downside of the first common electrode, and the second pattern contains a basic part deposed on topside of the second common electrode.

11. The liquid crystal display device as claimed in claim 10, wherein the first pattern further comprises two additional parts toward a direction of an obtuse angle with the ends of the basic part, and the second pattern further comprises two additional parts toward a direction of an obtuse angle with the ends of the basic part.

12. The liquid crystal display device as claimed in claim 1, wherein the first pixel and the second pixel are in a vertical and horizontal alternative arrangement.

13. The liquid crystal display device as claimed in claim 1, wherein the first pixel and the second pixel are respectively arranged in a row, and the row of the first pixel and that of the second pixel are in a vertical alternative arrangement.

14. The liquid crystal display device as claimed in claim 1, wherein the first pixel and the second pixel are respectively arranged in a line, and the line of the first pixel and that of the second pixel are in a horizontal alternative arrangement.

15. The liquid crystal display device as claimed in claim 1, wherein the first pattern or second pattern is a protrusion or opening.

16. An electronic device, comprising the liquid crystal display device as claimed in claim 1.

17. The electronic device as claimed in claim 16, wherein the electronic device comprises one of in-vehicle display devices, mobile phone devices, digital cameras, personal digital assistants, portable computers, desktop computers, television receivers, portable DVD players, portable blue-disc players.

18. A method of manufacturing a liquid crystal display device, comprising:
providing a first substrate;
forming a first pixel electrode of a first pixel and a second pixel electrode of a second pixel on the first substrate, wherein the first pixel and the second pixel are adjacent;
providing a second substrate on the opposite side of the first substrate;
disposing a liquid crystal layer between the first and second substrates,
wherein the liquid crystal layer comprises a plurality of first liquid crystal molecules and second crystal molecules;
forming a first common electrode and a second common electrode on the second substrate, respectively opposite to the first pixel electrode and the second pixel electrode;
forming a first pattern on the first common electrode; and
forming a second pattern on the second common electrode;
wherein the second pattern causes the second liquid crystal molecules corresponding to the second pixel electrode aligned asymmetrically.

19. The method of manufacturing a liquid crystal display device as claimed in claim 18, wherein the first liquid crystal molecules corresponding to the first pixel electrode are aligned in a vertical and horizontal symmetry.

20. The method of manufacturing a liquid crystal display device as claimed in claim 18, wherein the first pattern causes the first liquid crystal molecules corresponding to the first pixel electrode aligned asymmetrically.
